(19) United States
(12) Patent Application Publication
(10) Pub. No.: US 2011/0076419 A1
(43) Pub. Date: Mar. 31, 2011

(54) METHOD FOR DEVELOPING FINE GRAINED, THERMALLY STABLE METALLIC MATERIAL

(75) Inventors: Qi Yang, Farmington Hills, MI (US); Kazutaka Okamoto, Ibaraki (JP); Seunghwan Park, Ibaraki (JP)

(73) Assignee: Hitachi America, Ltd.

(21) Appl. No.: 12/568,114

(22) Filed: Sep. 28, 2009

(51) Int. Cl. B05D 3/12; B23K 20/12; C21D 1/34; C21D 1/70; B05D 3/06

(52) U.S. Cl. 427/554; 228/112.1; 148/559; 148/714; 148/537

(57) ABSTRACT

A method for developing fine grained, thermally stable metallic material in which friction stir welding or friction stir processing is performed along at least a portion of the material. Thereafter, a thin layer is removed from either side, or both sides of the material to eliminate the origin of abnormal grain growth occurring when the friction stir welded or friction stir processed material is subjected to subsequent hot forming processes. A sheet of extraneous material is optionally attached to either side, or both sides of the material prior to the friction stir welding or friction stir processing, and this extraneous material is removed after the friction stir welding or friction stir processing. A layer containing pinning particles or a sheet of extraneous material containing pinning particles is further optionally introduced on either side, or both sides of the material prior to the friction stir processing.

### BACKGROUND OF THE INVENTION

I. Field of the Invention

The present invention relates generally to a method for developing a fine grained thermally stable metallic material.

II. Description of Related Art

It is necessary to use fine grained, thermally stable materials where the materials are subsequently used to form complex components through hot forming processes. Such fine grained materials are required since large grains appearing in the material may subject the material to fracture or other failures prematurely during subsequent hot forming processes.

Fine grained metallic materials are usually prepared by conventional severe plastic deformation processes, such as accumulative roll bonding, reciprocating extrusion, and equal channel angular extrusion. These processes could involve elaborate surface preparations for the workpieces, the necessity to preheat the workpiece, and the presence of large friction between the dies and the workpieces. As such, it is difficult to utilize these severe plastic deformation processes to prepare fine grained bulk materials.

It has also been previously known that subjecting the metallic material to friction stir welding results in a fine-grained microstructure in the weld zone. As such, friction stir processing has been developed using the friction stir welding tool to produce fine grained bulk materials. Friction stir welding can be regarded as a single pass of friction stir processing. As known, a friction stir welding tool consists of a tool shoulder and a hard pin of any profile. The hard pin has a pin length slightly less than the thickness of the material or blank to be welded or processed. During friction stir welding or friction stir processing, the hard pin is fully penetrated into the material or blank, and the tool shoulder is in close contact with the top surface of the material or blank. Along the thickness, the friction stir welded or friction stir processed material or blank is divided in sequence into the weld/bead surface region or so-called top layer (in contact with the tool shoulder), the stir zone, and the region underneath the welding tool or so-called bottom layer.

However, such fine grain microstructure within the metallic materials developed by friction stir welding or friction stir processing oftentimes undergoes abnormal grain growth when subsequently exposed to high forming temperatures. Abnormal grain growth is originated from the weld surface region, or the region underneath the welding tool, or both where the processed material retains the deformed or unrecrystallized microstructure. This remaining deformed or unrecrystallized microstructure stores excessive free energy, and is so unstable at high temperatures that a set of grains grow at a high rate and at the expense of their neighbors, resulting in the formation of a microstructure dominated by a few very large grains. Abnormal grain growth can propagate throughout the entire stir zone for a prolonged duration. The microstructural instability results in substantial degradation of deformability and other mechanical properties of the friction stir welded or friction stir processed materials at high temperatures.

Consequently, because of the occurrence of abnormal grain growth during exposure to high temperatures, the fine grained metallic materials or blanks prepared by friction stir welding or friction stir processing are oftentimes not suitable for subsequent hot forming operations.

### SUMMARY OF THE PRESENT INVENTION

The present invention provides a method for developing a fine grained thermally stable metallic material which overcomes the above-mentioned disadvantages of the previously known methods.

As stated, at high temperatures, abnormal grain growth occurring in the friction stir welded or friction stir processed material is originated from the top surface layer, or the bottom surface layer, or both, and then propagates throughout the entire stir zone. Proper treatments are conducted to either of the surface layers, or both where abnormal grain growth is induced during the subsequent exposure of the processed material to high temperatures. To describe the concept of the present invention, both surface layers are chosen for proper treatments to eliminate the origin of abnormal grain growth. If only one surface layer induces abnormal grain growth during subsequent exposure of the friction stir welded or friction stir processed material to high temperature, then only that surface is required for proper treatments.

In brief, in one embodiment of the method of the present invention, friction stir processing is performed with the welding tool being plunged from one side of the metallic material or blank into the metallic material or blank until the entire metallic material is subjected to friction stir processing. Thereafter, the top and bottom layers of the friction stir processed metallic material are removed by any conventional means, such as grinding, to remove the material adjacent to the surfaces retaining deformed or unrecrystallized microstructure. After such removal, the remaining processed material is composed entirely of a substantially thermally stable fine grained microstructure.

Optionally, extraneous sheets of a compatible material are attached to both sides of the metallic material or blank to form a sheet stack. Friction stir processing is then performed on the sheet stack with the welding tool being plunged from one extraneous sheet through the metallic blank into the other extraneous sheet until the metal sheet stack is entirely friction stir processed.

Following the friction stir processing, the deformed or unrecrystallized microstructure resides entirely within the extraneous material sheets. The extraneous material is then removed from the metal blank by grinding or other conventional means.

In certain operations, such as welding a butt joint between two abutting metal blanks, extraneous sheets of compatible material are attached to the abutting blanks so that the compatible material extends along both the top and bottom surfaces of the abutting blanks along the seam. The friction stir welding is then performed along the seam with the welding tool being plunged from one extraneous sheet through the abutting blanks into the other extraneous sheet, thus welding the two blanks together. Afterwards, the compatible material is removed by grinding or other conventional means from both sides of the now conjoined metal blanks.

In an alternate form of the invention, a layer containing pinning particles, such as oxide powders, is deposited on both sides of the metal blank by any conventional means, such as laser powder deposition. Thereafter, friction stir processing is performed on the metal blank, thus intermixing the pinning particles into the top and bottom surface layers of the metal blank. In practice, the pinning particles impose resistance to the migration of the grain boundaries in the surface layers during exposure of the friction stir processed material to high temperatures, thus preventing the origination of abnormal grain growth from the surfaces of the blank and its propagation throughout the entire processed blank so that a fine grained thermally stable blank is obtained following friction stir processing.

Optionally, extraneous metal sheets containing a sufficient amount of pinning particles are attached to both sides of the metallic material or blank to form a sheet stack. Friction stir processing is then performed on the sheet stack with the welding tool being plunged from one extraneous sheet through the metallic blank into the other extraneous sheet until the metal sheet stack is entirely processed. Thereafter, a fine grained thermally stable blank is obtained following the friction stir processing.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is an elevational view illustrating one embodiment of the present invention;

FIG. 2 is an elevational view illustrating a still further embodiment of the present invention;

FIGS. 3A-3E are end sectional views illustrating a still further embodiment of the present invention;

FIG. 4 is an elevational view illustrating a still further embodiment of the present invention;

FIG. 5 is a flowchart illustrating one embodiment of the present invention;

FIG. 6 is a view similar to FIG. 4, but illustrating a still further embodiment of the present invention; and

FIG. 7 is a flowchart of the embodiment shown in FIG. 6.

### DETAILED DESCRIPTION OF PREFERRED EMBODIMENTS OF THE PRESENT INVENTION

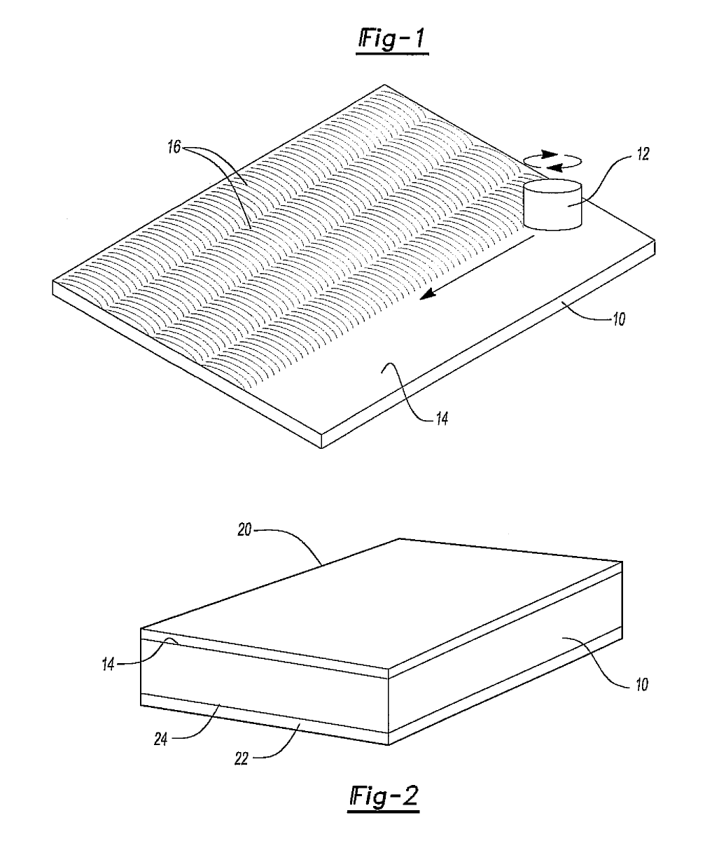

With reference first to FIG. 1, a metallic material or blank 10 is illustrated which will subsequently be used in a hot forming process to form a final part. The blank 10 illustrated in FIG. 1, by way of example, is made of an aluminum alloy containing 3.0Mg, 0.4Fe, 0.4Si, and 0.5Mn by weight percentage.

In order to form the blank 10 into a blank having a fine grained thermally stable microstructure, a friction stir welding tool 12, plunging from one side 14, performs friction stir processing on the blank 10 using multiple and overlapping passes 16. Although the friction stir processing creates a fine grained microstructure throughout the bank 10, abnormal grain growth often takes place at the surface layers of the friction stir processed blank 10 and then propagates throughout the entire stir zone to release excessive free energy when the friction stir processed blank 10 is subsequently exposed to high temperatures.

With reference now to FIG. 2, in order to prevent the propagation of abnormal grain growth throughout the friction stir processed blank 10 during subsequent exposure to high temperatures, a sheet 20 of compatible material is attached across the upper surface 14 of the blank 10, and a second sheet 22 of compatible material is attached to the opposite or bottom side 24 of the blank 10. Although the sheets 20 and 22 of extraneous material may be the same material as the blank 10, as used herein “compatible” means the absence of formation of large quantities of low melting-point intermetallic compounds between the extraneous sheets 20 and 22 and the blank 10.

The sheets 20 and 22 of extraneous material are preferably 0.5-0.8 millimeters in thickness and are attached to the blank 10 to form a sheet stack, Friction stir processing is then performed on the metal sheet stack with the welding tool being plunged from the sheet 20 through the blank 10 into the sheet 22 using multiple and overlapping passes as shown in FIG. 1 until the entire blank has been subjected to friction stir processing.

Following the friction stir processing of the blank 10 covered by the sheets 20 and 22 of extraneous material, any deformed or unrecrystallized microstructure is contained in the sheets 20 and 22 of extraneous material which undergoes abnormal grain growth during subsequent exposure to high temperatures, while the blank 10 is subjected only to the stir zone during the friction stir processing which has a thermally stable microstructure even at high temperatures, Consequently, by removal of the extraneous sheets 20 and 22 through any conventional means, such as grinding, a fine grained and thermally stable blank 10 remains. The blank 10 is then typically subjected to subsequent hot forming processes.

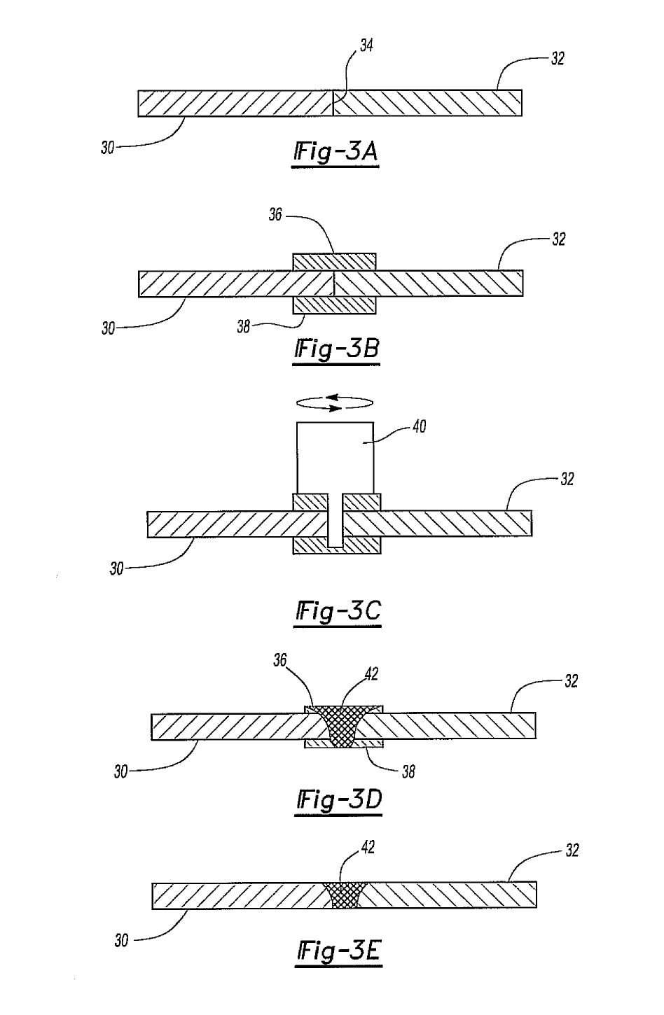

With reference now to FIGS. 3A-3E, a modification to the present invention is illustrated. In FIG. 3A two metal sheets 30 and 32 are butted together along a butt line or seam 34 to be joined into a Tailor-Welded Blank. The concept of combining different materials or sheets into a welded blank is developed to enable the design engineers to tailor the blank so that the materials' best properties are located precisely in the component where they are needed. It is desired to secure the two metal sheets 30 and 32 together along the seam 34 as well as develop a fine grained and thermally stable microstructure along the seam 34 using friction stir welding so that the welded blank is not subjected to premature failure around the weld region during subsequent hot forming processes.

In order to achieve this, a sheet 36 of extraneous material overlies the top of the seam 34 along the top of the blanks 30 and 32 while, similarly, a sheet 38 of extraneous material overlies the seam line 34 along the bottom of the blanks 30 and 32. The sheets 36 and 38 of extraneous material are compatible with the blanks 30 and 32 and are attached to the blanks 30 and 32 in any conventional fashion.

As shown in FIG. 3C, friction stir welding is performed along the seam 34 with the welding tool 40 being plunged from the sheet 36 through the blanks 30 and 32 into the sheet 38, thus joining the blanks 30 and 32 together along the seam 34. The resulting weld is illustrated in FIG. 3D in which a weld region 42 between the blanks 30 and 32 contains fine grained, thermally stable material while any deformed or unrecrystallized microstructure is contained in the sheets 36 and 38 of extraneous material. The sheets 36 and 38 containing deformed or unrecrystallized microstructure and inducing abnormal grain growth at later hot forming processes are then removed by any conventional means, such as grinding, from the blanks 30 and 32 as shown in FIG. 3E. Consequently, only fine grained and thermally stable material remains in the weld zone 42 between the two blanks 30 and 32.

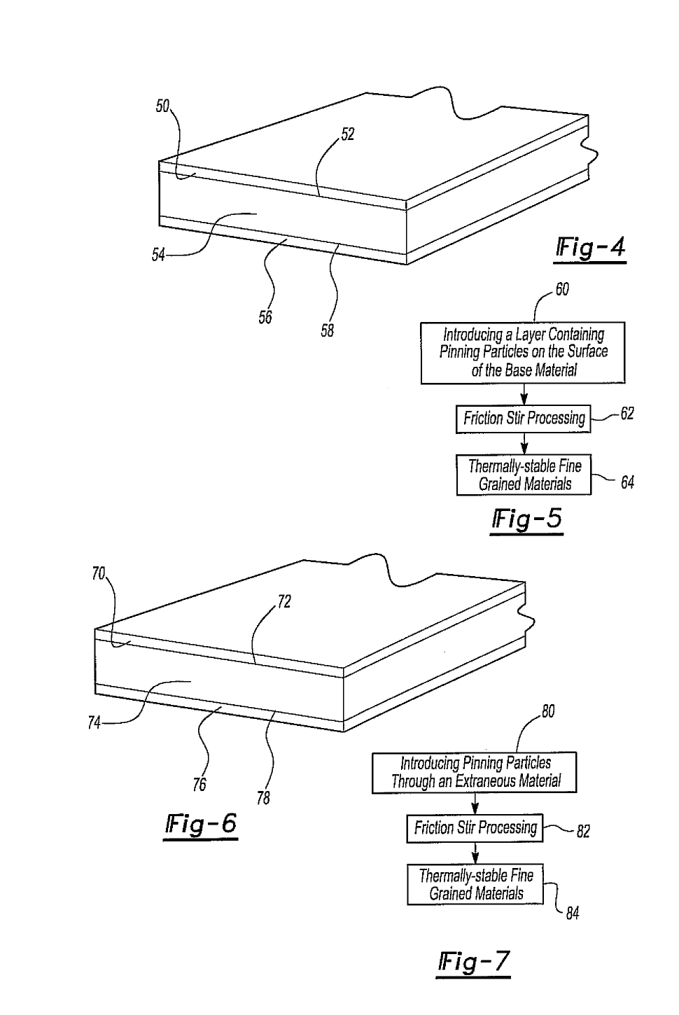

With reference now to FIGS. 4 and 5, a still further embodiment of the present invention is shown in which a layer 50 containing pinning particles is deposited on one side 52 of the metallic blank 54, and similarly a second layer 56 containing pinning particles is deposited on the opposite side 58 of the metallic blank 54. Any conventional method, such as laser powder deposition, may be used to form the layers 50 and 56. The layers 50 and 56 preferably comprise an oxide powder such as alumina or silica of submicron or nanometric size.

As best shown in FIGS. 4 and 5, after the step 60 of creating the layers 50 and 56 containing pinning particles, step 60 proceeds to step 62 in which friction stir processing is performed on the metal blank 54 covered by the layers 50 and 56. Upon completion of the friction stir processing at step 62, the friction stir processing intermixes the pinning particles into the surfaces 52 and 58 of the blank 54. The pinning particles mainly located in the layers 50 and 56, in turn, restrict the migration of the grain boundaries and therefore prevent abnormal grain growth in the layers 50 and 56, and further prevent the propagation of abnormal grain growth into the blank 54 to be exposed to high temperatures so that the resulting blank 54 along with the layers 50 and 56 has a fine grained and thermally stable microstructure.

With reference now to FIGS. 6 and 7, a still further embodiment of the invention is shown in which sheets 70 and 76 of extraneous material and containing pinning particles are attached to the top surface 72 and bottom surface 78 of a metal blank 74 to form a metal sheet stack at step 80. As before, the sheets 70 and 76 containing pinning particles must be compatible with the material of the blank 74.

Friction stir processing is then performed at step 82 on the metal sheet stack comprising the sheets 70 and 76 containing pinning particles and the blank 74. During the friction stir processing, the welding tool intermixes the pinning particles contained in the sheets 70 and 76 into the metal blank 74 along the surfaces 72 and 78 of the blank 74.

Upon completion of the friction stir processing at step 82, the pinning particles from the extraneous sheets 70 and 76 are intermixed with the blank 74 along its top surface 72 and its bottom surface 78. These pinning particles mainly located in the extraneous sheets 70 and 76 restrict the migration of the grain boundaries and therefore prevent abnormal grain growth in the extraneous sheet 70 and 76, and further prevent the propagation of abnormal grain growth into the blank 74 to be exposed to high temperatures so that the resulting joined metal sheet stack comprising the blank 74 and the sheets 70 and 76 is fine grained and thermally stable.

From the foregoing, it can be seen that the present invention provides a simple and yet effective method for forming metal blanks with fine grained and thermally stable microstructure and thus increased high temperature formability. Having described our invention, however, many modifications thereto will become apparent to those skilled in the art to which it pertains without deviation from the spirit of the invention as defined by the scope of the appended claims.

We claim:

1. A method for developing a fine grained, thermally stable metallic material comprising the steps of:
performing friction stir processing on at least a portion of the material,
thereafter, removing a layer having a predetermined thickness from said at least a portion of one side of the friction stir processed material.

2. The method as defined in claim 1 wherein said predetermined thickness is less than 1 millimeter.

3. The method as defined in claim 1 wherein said predetermined thickness is in the range of 0.5-0.8 millimeter.

4. The method as defined in claim 1 wherein said removing is conducted on both sides of said friction stir processed material.

5. The method as defined in claim 1 and comprising the step of first covering said at least a portion of one side of the material with a sheet of compatible extraneous material prior to said friction stir processing and wherein said removing step comprises the step of removing said extraneous material.

6. The method as defined in claim 1 and comprising the step of first covering said at least a portion of the other side of the material with a sheet of compatible extraneous material prior to said friction stir processing and wherein said removing step comprises the step of removing said extraneous material.

7. The method as defined in claim 5 and comprising the step of first covering said at least a portion of the other side of the material with a sheet of compatible extraneous material prior to said friction stir processing so that said sheets of compatible extraneous materials are aligned with each other.

8. A method for developing a fine grained, thermally stable welding seam between two blanks of metallic material comprising the steps of:
abutting the blanks together along the seam,
covering one side of the seam with a compatible extraneous metal sheet,
thereafter performing friction stir welding on said blanks along said seam,
thereafter, removing the extraneous metal sheet.

9. The method as defined in claim 8 and comprising the step of covering the other side of the seam with a compatible extraneous metal sheet prior to said friction stir welding step, said sheets of compatible material being aligned with each other.

10. A method for developing a fine grained, thermally stable metallic material comprising the steps of:
introducing a layer comprising pinning particles along at least a portion of one side of the material, and
thereafter performing friction stir processing on said at least a portion of the material.

11. The method as defined in claim 10 wherein said introducing step comprises the step of laser powder deposition on said one side of the material, said powders including a sufficient amount of pinning particles.

12. The method as defined in claim 10 and comprising the step of introducing a layer containing pinning particles along at least a portion of the other side of the material, these two portions being aligned with each other.

13. The method as defined in claim 11 wherein said introducing step comprises the step of laser powder deposition on said other side of the material.

14. The method as defined in claim 12, wherein said at least a portion of one side of the material comprises the entire one side of the material, and said at least a portion of the other side of the material comprises the entire other side of the material.

15. The method as defined in claim 10 wherein said introducing step comprises the step of attaching a sheet of compatible extraneous material containing pinning particles onto said one side of the material.

16. The method as defined in claim 15, wherein said introducing step comprises the step of attaching a sheet of compatible extraneous material containing pinning particles onto said other side of the material.

17. The method as defined in claim 15 wherein said pinning material comprises an oxide powder.

18. The method as defined in claim 17 wherein said oxide powder comprises alumina.

19. The method as defined in claim 17 wherein said oxide powder comprises silica.
